(19) United States
(12) Patent Application Publication
(10) Pub. No.: US 2005/0244652 A1
(43) Pub. Date: Nov. 3, 2005

(54) Radiation curable polyurethanes with capped amino groups

(75) Inventors: Eva Wagner, Speyer (DE); Riner Koniger, Clifton Park, NY (US); Bernd Bruchmann, Freinsheim (DE); Hans Renz, Meckenheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Basf Aktiengesellschaft, Ludwigshafen (DE)

(21) Appl. No.: 10/526,017

(22) PCT Filed: Aug. 28, 2003
(86) PCT No.: PCT/EP03/09512

§ 371 Date: Feb. 25, 2005

(51) Int. Cl. B32B 27/40; C08L 75/04; C08G 18/00

(52) U.S. Cl. 428/423.1; 525/452; 528/44

(57) ABSTRACT

Polyurethanes containing at least one free radically or cationically polymerizable unsaturated group and at least one capped amino group.

The invention relates to radiation curable compounds containing capped amino groups and if desired capped or uncapped isocyanate groups and to their use in dual cure and multicure systems.

Examples of suitable capping agents for NCO groups include oximes, phenols, imidazoles, pyrazoles, pyrazolinones, diketopiperazines, caprolactam, malonic esters, and compounds as stated in the publications by Z. W. Wicks in Prog. Org. Coat. 3 (1975) 73-99 and Prog. Org. Coat 9 (1981), 3-28 and also in Houben-Weyl, Methoden der Organischen Chemie, Vol. XIV/2, p. 61 ff., Georg Thieme Verlag, Stuttgart 1963.

Dual cure systems feature curability by two independent curing mechanisms, e.g., by radiation, moisture, oxidative or thermal curing. A particular desire is for systems which following application of the coating material can be precured by very brief irradiation to give a film which is flexible and dust dry. This film should then either be amenable to a thermal aftercure or should continue to full cure by means of simple storage for a few days in air until a hard film has developed which has the desired ultimate service properties. This type of two stage curing is of particular importance on account of the fact that it offers coating systems processors the opportunity to coat an article with a film in a first workstep and to subject this film to further processing in a further workstep, in particular by imparting a certain profile to the coated article following irradiation, using pressure. It is therefore necessary for the films to be in a precured state when they are deformed in the second workstep, so that they do not stick to the tools during their deformation, but they must not be so hard that they crack when stretched and deformed.

The terms “dual cure” and “multicure” refer in accordance with the invention to a curing operation which is accomplished by way of two or more than two mechanisms, respectively, with curing taking place by means of radiation, moisture, chemicals, oxidation or heat.

WO 00/39183 describes free radically polymerizable compounds containing urethane and allophanate groups and activated C═C double bonds.

Such compounds possess only one curing mechanism, viz. radiation.

DE-A1 196 09 617 and WO 97/23536 describe compounds containing isocyanate groups and capped, isocyanate reactive groups, such as oxazolidines, for one and two component polyurethane coating compositions.

Such compounds are only moisture curable, necessitating long cure times and leading to soft films.

WO 01/83579 describes multicomponent coating systems comprising an adduct of a diisocyanate containing oxazolidine, for example, and a (meth)acrylate copolymer containing hydroxy groups.

In the absence of double bonds, however, the adducts described cannot be radiation cured in the fully polymerized (meth)acrylate copolymer and so neccesitate cure times of generally at least 30 minutes. A radiation cure is only possible when radiation curable components are admixed independently of the adduct.

DE-A1 100 47 989 describes dual cure multicomponent coating materials which comprise an adduct of a urethane formed from hexamethylene diisocyanate, containing isocyanate groups for example, and an oxazolidine and also a hydroxyl-containing and radiation curable (meth)acrylate copolymer. The copolymer used advantageously has molecular weights Mₙ of from 1 000 to 20 000 and M_{w} of from 2 000 to 100 000 daltons.

A disadvantage of these systems is that owing to the high molecular weights of the copolymer used the resultant adducts also have high molecular weights and, accordingly, high viscosities.

It is an object of the present invention to provide radiation curable dual cure or multicure systems which have a low viscosity and exhibit good surface properties.

We have found that this object is achieved by polyurethanes (A) comprising as synthesis components
a) at least one organic diisocyanate or polyisocyanate,
b) at least one compound containing at least one isocyanate-reactive group and at least one free radically polymerizable unsaturated group and/or cationically polymerizable group,
c) at least one compound containing at least one isocyanate-reactive group and at least one capped amino group and having a molecular weight below 1000 g/mol,
d) if desired, at least one compound containing at least one isocyanate-reactive group and at least one actively dispersing group,
e) if desired, at least one compound containing at least two isocyanate-reactive groups, and
f) if desired, compounds other than a) to d) containing at least one isocyanate-reactive group.

The number average molecular weight Mₙ of these compounds (A), determined by gel permeation chromatography using tetrahydrofuran eluent and polystyrene standards, can be for example between 200 and 50 000, preferably between 250 and 30 000, more preferably between 350 and 10 000, and in particular between 350 and 5 000.

The amount of unsaturated free radically or cationically polymerizable groups can be for example at least 0.01 mol/100 g compound, preferably at least 0.05, more preferably at least 0.1, and in particular at least 0.2 mol/100 g.

The amount of capped amino groups can be for example at least 0.01 mol/100 g compound, preferably at least 0.05, more preferably at least 0.1, and in particular at least 0.2 mol/100 g.

The polyurethanes (A) of the invention comprise as synthesis components essentially the above-recited components a), b), and c), and also, if desired, components d), e), and/or f).

We have found that the aforementioned object is likewise achieved by polyurethane dispersions which can be processed as aqueous systems and essentially comprise
(A) a polyurethane which includes component d),
(C) if desired, one or more photochemically and/or thermally activable initiators, and
(D) if desired, further typical coatings additives.

The compounds (C) and (D) can also be added to the polyurethanes if it is desired to provide coating formulations for preparing dual cure coating materials.

Suitable components a) include for example aliphatic, aromatic, and cycloaliphatic diisocyanates and polyisocyanates having an NCO functionality of at least 1.8, preferably from 1.8 to 5, and more preferably from 2 to 4, and also their isocyanurates, biurets, urethanes, allophanates, and uretdiones.

The diisocyanates are preferably isocyanates having 4 to 20 carbon atoms. Examples of common diisocyanates are aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate, trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4-, or 2,6-diisocyanato-1-methylcyclohexane and also aromatic diisocyanates such as 2,4- or 2,6-tolylene diisocyanate and the isomer mixtures thereof, m- or p-xylylene diisocyanate, 2,4′- or 4,4′-diisocyanatodiphenylmethane and the isomer mixtures thereof, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Mixtures of said diisocyanates may also be present.

Examples of suitable common isocyanates containing on average at least 2 isocyanate groups include triisocyanates such as 2,4,6-triisocyanatotoluene, triphenylmethane triisocyanate or 2,4,4′-triisocyanatodiphenyl ether or the mixtures of di-, tri-, and higher polyisocyanates which are obtained by phosgenating corresponding aniline/formaldehyde condensates and constitute polyphenyl polyisocyanates with methylene bridges.

Suitable polyisocyanates include polyisocyanates containing isocyanurate groups, uretdione diisocyanates, polyisocyanates containing biuret groups, polyisocyanates containing urethane or allophanate groups, polyisocyanates containing oxadiazinetrione or iminooxadiazinedione groups, uretonimine-modified polyisocyanates of straight-chain or branched C₄-C₂₀ alkylene diisocyanates, cycloaliphatic diisocyanates having 6 to 20 carbon atoms in all or aromatic diisocyanates having 8 to 20 carbon atoms in all, or mixtures thereof.

The diisocyanates and polyisocyanates which can be used preferably have an isocyanate group content (calculated as NCO, molecular weight=42) of from 10 to 60% by weight, based on the diisocyanate and polyisocyanate (mixture), more preferably from to 60% by weight, and very preferably from 20 to 55% by weight.

Preference is given to aliphatic and/or cycloaliphatic diisocyanates and polyisocyanates, examples being the aliphatic and cycloaliphatic diisocyanates, respectively, that have been mentioned above, or to mixtures thereof.

Hexamethylene diisocyanate, 1,3-bis(isocyanatomethyl)cyclohexane, isophorone diisocyanate, and di(isocyanatocyclohexyl)methane, are particularly preferred, isophorone diisocyanate and hexamethylene diisocyanate are very particularly preferred, and hexamethylene diisocyanate is especially preferred.

Preference is extended to
1) polyisocyanates containing isocyanurate groups and derived from aromatic, aliphatic and/or cycloaliphatic diisocyanates.

Particularly preferred here are the corresponding aliphatic and/or cycloaliphatic isocyanato isocyanurates and in particular those based on hexamethylene diisocyanate and isophorone diisocyanate. The isocyanurates present are, in particular, trisisocyanatoalkyl or trisisocyanatocycloalkyl isocyanurates, which constitute cyclic trimers of the diisocyanates, or mixtures with their higher homologs containing more than one isocyanurate ring. The isocyanato isocyanurates generally have an NCO content of from 10 to 30% by weight, in particular from 15 to 25% by weight, and an average NCO functionality of from 2.6 to 4.5.
2) Uretdione diisocyanates having aromatically, aliphatically and/or cycloaliphatically attached isocyanate groups, preferably aliphatically and/or cycloaliphatically attached groups, and in particular those derived from hexamethylene diisocyanate or isophorone diisocyanate. Uretdione diisocyanates are cyclic dimerization products of diisocyanates. In the formulations of the invention the uretdione diisocyanates can be used as a component alone or in a mixture with other polyisocyanates, particularly those specified under 1).

3) Polyisocyanates containing biuret groups and having aromatically, cycloaliphatically or aliphatically, preferably cycloaliphatically or aliphatically, attached isocyanate groups, especially tris(6-isocyanatohexyl)biuret or its mixtures with its higher homologs. These polyisocyanates containing biuret groups generally have an NCO content of from 18 to 22% by weight and an average NCO functionality of from 2.8 to 4.5.

4) Polyisocyanates containing urethane and/or allophanate groups and aromatically, aliphatically or cycloaliphatically, preferably aliphatically or cycloaliphatically, attached isocyanate groups, as are obtainable for example by reacting excess amounts of hexamethylene diisocyanate or of isophorone diisocyanate with monohydric or polyhydric alcohols such as methanol, ethanol, iso-propanol, n-propanol, n-butanol, iso-butanol, sec-butanol, tert-butanol, n-hexanol, n-heptanol, n-octanol, n-decanol, n-dodecanol (lauryl alcohol), 2-ethylhexanol, n-pentanol, stearyl alcohol, cetyl alcohol, lauryl alcohol, ethylene glycol monomethyl ether, ethylene glycol monoethyl ether, 1,3-propanediol monomethyl ether, cyclopentanol, cyclohexanol, cyclooctanol, cyclododecanol, trimethylolpropane, neopentylglycol, pentaerythritol, 1,4-butanediol, 1,6-hexanediol, 1,3-propanediol, 2-ethyl-1,3-propanediol, 2-methyl-1,3-propanediol, ethylene glycol, diethylene glycol, triethylene glycol, tetraethylene glycol, pentaethylene glycol, glycerol, 1,2-dihydroxypropane, 2,2-dimethyl-1,2-ethanediol, 1,2-butanediol, 1,4-butanediol, 3-methylpentane-1,5-diol, 2-ethylhexane-1,3-diol, 2,4-diethyloctane-1,3-diol, neopentylglycol hydroxypivalate, ditrimethylolpropane, dipentaerythritol, 2,2-bis(4-hydroxycyclohexyl)propane, 1,1-, 1,2-, 1,3- and 1,4-cyclohexanedimethanol, 1,2-, 1,3- or 1,4-cyclohexanediol or mixtures thereof. These polyisocyanates containing urethane and/or allophanate groups generally have an NCO content of from 12 to 20% by weight and an average NCO functionality of from 2.5 to 4.5.
5) Polyisocyanates containing oxadiazinetrione groups, preferably derived from hexamethylene diisocyanate or isophorone diisocyanate. Polyisocyanates of this kind containing oxadiazinetrione groups can be prepared from diisocyanate and carbon dioxide.
6) Polyisocyanates containing iminooxadiazinedione groups, preferably derived from hexamethylene diisocyanate or isophorone diisocyanate. Polyisocyanates of this kind containing iminooxadiazinedione groups can be prepared from diisocyanates by means of specific catalysts.
7) Uretonimine-modified polyisocyanates.

Polyisocyanates 1) to 7) can be used in a mixture, including where appropriate a mixture with diisocyanates.

Suitable components b) are compounds which carry at least one isocyanate-reactive group and at least one free radically or cationically polymerizable group.

Examples of possible isocyanate-reactive groups include —OH, —SH, —NH₂ and —NHR⁴, with R⁴ being hydrogen or C₁-C₄ alkyl.

C₁-C₄ Alkyl for the purposes of this specification means methyl, ethyl, iso-propyl, n-propyl, n-butyl, iso-butyl, sec-butyl or tert-butyl.

Polymerizable groups can be those which have unsaturated bonds, preferably carbon-carbon double bonds.

Free radically polymerizable groups are for example isolated ethylenically unsaturated groups, conjugated unsaturated groups, vinylaromatic groups, groups of vinyl chloride and vinylidene chloride type, N-vinyl amides, vinylpyrrolidones, vinyllactams, vinyl esters, (meth)acrylic esters or acrylonitriles.

Examples of cationically polymerizable groups include isobutylene units and vinyl ethers.

Examples of components b) are monoesters of α,β-unsaturated carboxylic acids, such as acrylic acid, methacrylic acid (referred to together in this specification as “(meth)acrylic acid” for short), crotonic acid, itaconic acid, fumaric acid, maleic acid, acrylamidoglycolic acid, methacrylamidoglycolic acid or vinyl ethers with diols or polyols having preferably 2 to 20 carbon atoms and at least two hydroxyl groups, such as ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,4-butanediol, 1,5-pentanediol, neopentylglycol, neopentylglycol hydroxypivalate, 2-ethyl-1,3-propanediol, 2-methyl-1,3-propanediol, 1,6-hexanediol, 2-methyl-1,5-pentanediol, 2-ethyl-1,4-butanediol, 2-ethyl-1,3-hexanediol, 2,4-diethyloctane-1,3-diol, 2,2-bis(4-hydroxycyclohexyl)propane, 1,1-, 1,2-, 1,3- and 1,4-bis(hydroxymethyl)cyclohexane, 1,2-, 1,3- or 1,4-cyclohexanediol, glycerol, trimethylolethane, trimethylolpropane, trimethylolbutane, pentaerythritol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, Isomalt, polyTHF having a molar weight of between 162 and 378, poly-1,3-propanediol or polypropylene glycol with a molar weight between 134 and 400 or polyethylene glycol with a molar weight between 238 and 458. It is also possible to use esters or amides of (meth)acrylic acid with amino alcohols, e.g., 2-aminoethanol, 2-(methylamino)ethanol, 3-amino-1-propanol, 1-amino-2-propanol or 2-(2-aminoethoxy)ethanol, 2-mercaptoethanol or polyaminoalkanes, such as ethylenediamine or diethylenetriamine, or vinylacetic acid as well.

Also suitable in addition are unsaturated polyetherols or polyesterols or polyacrylate polyols having an average OH functionality of from 2 to 10.

Examples of amides of ethylenically unsaturated carboxylic acids with amino alcohols are hydroxyalkyl(meth)acrylamides such as N-hydroxymethylacrylamide, N-hydroxymethylmethacrylamide, N-hydroxyethylacrylamide, N-hydroyxethylmethacrylamide, 5-hydroxy-3-oxapentyl(meth)acrylamide, N-hydroxyalkylcrotonamides such as N-hydroxymethylcrotonamide or N-hydroxyalkylmaleimides such as N-hydroxyethylmaleimide.

Preference is given to using 2-hydroxyethyl (meth)acrylate, 2- or 3-hydroxypropyl (meth)acrylate, 1,4-butanediol mono(meth)acrylate, neopentylglycol mono(meth)acrylate, glyceryl mono- and di(meth)acrylate, trimethylolpropane mono- and di(meth)acrylate, pentaerythrityl mono-, di- and tri(meth)acrylate, and also 4-hydroxybutyl vinyl ether, 2-aminoethyl (meth)acrylate, 2-aminopropyl (meth)acrylate, 3-aminopropyl (meth)acrylate, 4-aminobutyl (meth)acrylate, 6-aminohexyl (meth)acrylate, 2-thioethyl (meth)acrylate, 2-aminoethyl (meth) acrylamide, 2-aminopropyl (meth)acrylamide, 3-aminopropyl (meth)acrylamide, 2-hydroxyethyl (meth)acrylamide, 2-hydroxypropyl (meth)acrylamide or 3-hydroxypropyl (meth)acrylamide. Particular preference is given to 2-hydroxyethyl acrylate, 2-hydroxyethyl methacrylate, 2- or 3-hydroxypropyl acrylate, 1,4-butanediol monoacrylate and 3-(acryloyloxy)-2-hydroxypropyl methacrylate.

Compounds suitable as component c) are those containing at least one isocyanate-reactive group and at least one capped amino group, with a molecular weight below 1000 g/mol, preferably below 750 g/mol, more preferably below 500 g/mol, and in particular below 250 g/mol.

Capped amino groups are those from which unsubstituted or monosubstituted amino groups can be liberated, and include, for example, open-chain or cyclic aminals, N,O-acetals, N,O-ketals, ketimines, aldimines, carboxamides, sulfonamides or amidines, preferably ketimines, aldimines, aminals, N,O-acetals, N,O-ketals or amidines, with particular preference aminals, ketimines, aldimines, N,O-acetals or N,O-ketals, and especially N,O-acetals.

Within this specification the term “capped” means that the structure in question, an amino group for example, is essentially stable under the reaction conditions of the preparation of the polyurethanes of the invention and of the radiation curable compositions and that it is only under the conditions of curing that the group is decomposed to effect significant liberation of the structure in question. “Essentially stable” here means that under the reaction conditions less than 10 mol % per hour, preferably less than 5 mol %/h, more preferably less than 2 mol %/h, and very preferably less than 1 mol %/h is decomposed.

Preferred compounds containing capped amino groups are oxazolidines, aldimines, and ketimines, as known for example from EP-A1 659 791, p. 6, line 26 to p. 7, line 13 and the examples, and from U.S. Pat. No. 5,922,804, col. 1, line 42 to col. 3, line 45, oxazolidines being particularly preferred.

The compounds c) may contain one or more capped amino groups, for example from 1 to 3, preferably from 1 to 2, and more preferably 1.

The compounds c) can contain one or more isocyanate-reactive groups, for example, from 1 to 3, preferably 1 or 2, and more preferably 1.

Compounds c) can for example be compounds containing at least one ring nitrogen atom that are of the type set out in DE-A1 196 09 617 on p. 2, line 31-59 and especially on p. 3 lines 33-55, or oxazolidines as described in DE-A 22 45 636 on p. 2 line 5 to p. 3 para. 3 and in Examples 1, 2, 5, 6 and 9.

Both documents are hereby expressly included in the present disclosure content by reference.

The preparation of β-hydroxyalkyloxazolidines is described in DE-A 22 45 636 on p. 3, para. 3 to p. 4 para. 1.

Preferred components c) are compounds of the formula (I), 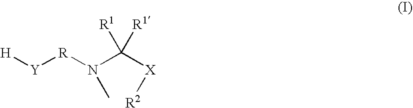
where
R and R² independently are each a divalent organic aliphatic, cycloaliphatic or aromatic radical containing 2 to 20 carbon atoms which is unsubstituted or substituted by functional groups, aryl, alkyl, aryloxy, alkyloxy, halogen, heteroatoms and/or heterocycles,
R¹ and R¹′ independently are each hydrogen, C₁-C₁₈ alkyl, C₂-C₁₈ alkyl which is uninterrupted or interrupted by one or more oxygen and/or sulfur atoms and/or by one or more substituted or unsubstituted imino groups, or is C₆-C₁₂ aryl, C₅-C₁₂ cycloalkyl or a five- or six-membered heterocycle containing oxygen, nitrogen and/or sulfur atoms, it being possible for each of said radicals to be substituted by functional groups, aryl, alkyl, aryloxy, alkyloxy, halogen, heteroatoms and/or heterocycles,
X is oxygen (—O—), unsubstituted or monosubstituted nitrogen (>NR⁴) or >N—NR⁴R⁵,
Y is oxygen (—O—), unsubstituted nitrogen (>NH) or sulfur (—S—), and
R⁴ and R⁵ independently are each hydrogen or C₁-C₄ alkyl.

Examples of R and R² are 1,2-ethylene, 1,2-propylene, 2-methyl-1,2-propylene, 1-phenyl-1,2-ethylene, 2′-aminoethyl-1,2-ethylene, 1-iso-propyl-1,2-ethylene, 1-tert-butyl-1,2-ethylene, 1-benzyl-1,2-ethylene, 1-phenyl-2-methyl-1,2-ethylene, 1-phenyl-2-methoxymethyl-1,2-ethylene, but-1-en-3,4-ylene, 1,3-propylene, 2-methyl-1,3-propylene, 2-ethyl-1,3-propylene, 1,4-butylene, 1,6-hexylene, 2,2-dimethyl-1,3-propylene, 2,2-dimethyl-1,4-butylene, 1,1-, 1,2-, 1,3- or 1,4-cyclohexylene, 1,2- or 1,3-cyclopentylene, 1,2-, 1,3- or 1,4-phenylene, 4,4′-biphenylene or 3-oxa-1,5-pentylene.

Preferably R and R² are each independently 1,2-ethylene, 1,2-propylene, 2-methyl-1,2-propylene or 1,3-propylene, more preferably 1,2-ethylene or 1,2-propylene, and very preferably 1,2-ethylene.

R¹ and R¹′ may independently each for example be hydrogen, methyl, ethyl, propyl, isopropyl, n-butyl, sec-butyl, tert-butyl, pentyl, hexyl, heptyl, octyl, 2-ethylhexyl, 2,4,4-trimethylpentyl, 2-methoxyethyl, 2-ethoxyethyl, 2-butoxyethyl, chloromethyl, 2-chloroethyl, trichloromethyl, trifluoromethyl, vinyl, 1-propenyl, benzyl, phenyl, tolyl, chlorophenyl, dichlorophenyl, 2,6-dimethylphenyl, 2,4,6-trimethylphenyl, 2,6-dimethoxyphenyl, 2,6-dichlorophenyl, cyclopentyl, cyclohexyl or furyl.

Preferably R¹ and R¹′ each independently are hydrogen, methyl, ethyl, propyl, isopropyl, n-butyl, sec-butyl, tert-butyl, phenyl, cyclopentyl, cyclohexyl or furyl, more preferably R¹ is hydrogen, methyl, ethyl, propyl or isopropyl and R¹′ is hydrogen, methyl or ethyl, very preferably R¹ is hydrogen, methyl or iso-propyl, and especially iso-propyl, and R¹′ is hydrogen, or R¹ and R¹′ are both methyl.

X is preferably oxygen (—O—) or unsubstituted or monosubstituted nitrogen (>NR⁴) and with particular preference oxygen.

Y is preferably oxygen (—O—) or unsubstituted nitrogen (>NH) and with particular preference oxygen.

Particularly preferred components c) are
N-(2′-hydroxyethyl)-oxazolidine,
N-(2′-hydroxyethyl)-2-methyloxazolidine,
N-(2′-hydroxyethyl)-2-ethyloxazolidine,
N-(2′-hydroxyethyl)-2-iso-propyloxazolidine,
N-(2′-hydroxyethyl)-2-propyloxazolidine,
N-(2′-hydroxyethyl)-2-phenyloxazolidine,
N-(2′-hydroxyethyl)-2,2-dimethyloxazolidine,
N-(2′-hydroxyethyl)-2,2-diethyloxazolidine,
N-(2′-hydroxyethyl)-4-methyloxazolidine,
N-(2′-hydroxyethyl)-2,4-dimethyloxazolidine,
N-(2′-hydroxyethyl)-2-ethyl-4-methyloxazolidine,
N-(2′-hydroxyethyl)-2-iso-propyl-4-methyloxazolidine,
N-(2′-hydroxyethyl)-2-propyl-4-methyloxazolidine,
N-(2′-hydroxyethyl)-2-phenyl-4-methyloxazolidine,
N-(2′-hydroxyethyl)-2,2,4-trimethyloxazolidine,
N-(2′-hydroxyethyl)-5-methyloxazolidine,
N-(2′-hydroxyethyl)-2,5-dimethyloxazolidine,
N-(2′-hydroxyethyl)-2-ethyl-5-methyloxazolidine,
N-(2′-hydroxyethyl)-2-isopropyl-5-methyloxazolidine,
N-(2′-hydroxyethyl)-2-propyl-5-methyloxazolidine,
N-(2′-hydroxyethyl)-2-phenyl-5-methyloxazolidine,
N-(2′-hydroxyethyl)-2,2,5-trimethyloxazolidine,
N-(2′-hydroxyethyl)-4,4-methyloxazolidine,
N-(2′-hydroxyethyl)-2,4,4-trimethyloxazolidine,
N-(2′-hydroxyethyl)-2-ethyl-4,4-dimethyloxazolidine,
N-(2′-hydroxyethyl)-2-isopropyl-4,4-dimethyloxazolidine,
N-(2′-hydroxyethyl)-2-propyl-4,4-dimethyloxazolidine,
N-(2′-hydroxyethyl)-2-phenyl-4,4-dimethyloxazolidine,
N-(2′-hydroxyethyl)-2,2,4,4-tetramethyloxazolidine,
N-(2′-hydroxypropyl)oxazolidine,
N-(2′-hydroxypropyl)-2-methyloxazolidine,
N-(2′-hydroxypropyl)-2-ethyloxazolidine,
N-(2′-hydroxypropyl)-2-isopropyloxazolidine,
N-(2′-hydroxypropyl)-2-propyloxazolidine,
N-(2′-hydroxypropyl)-2-phenyloxazolidine,
N-(2′-hydroxypropyl)-2,2-dimethyloxazolidine,
N-(2′-hydroxypropyl)-4-methyloxazolidine,
N-(2′-hydroxypropyl)-2,4-dimethyloxazolidine,
N-(2′-hydroxypropyl)-2-ethyl-4-methyloxazolidine,
N-(2′-hydroxypropyl)-2-isopropyl-4-methyloxazolidine,
N-(2′-hydroxypropyl)-2-propyl-4-methyloxazolidine,
N-(2′-hydroxypropyl)-2-phenyl-4-methyloxazolidine,
N-(2′-hydroxypropyl)-2,2,4-trimethyloxazolidine,
N-(2′-hydroxypropyl)-5-methyloxazolidine,
N-(2′-hydroxypropyl)-2,5-dimethyloxazolidine,
N-(2′-hydroxypropyl)-2-ethyl-5-methyloxazolidine,
N-(2′-hydroxypropyl)-2-isopropyl-5-methyloxazolidine,
N-(2′-hydroxypropyl)-2-propyl-5-methyloxazolidine,
N-(2′-hydroxypropyl)-2-phenyl-5-methyloxazolidine,
N-(2′-hydroxypropyl)-2,2,5-trimethyloxazolidine,
N-(2′-hydroxypropyl)-4,4-methyloxazolidine,
N-(2′-hydroxypropyl)-2,4,4-trimethyloxazolidine,
N-(2′-hydroxypropyl)-2-ethyl-4,4-dimethyloxazolidine,
N-(2′-hydroxypropyl)-2-isopropyl-4,4-dimethyloxazolidine,
N-(2′-hydroxypropyl)-2-propyl-4,4-dimethyloxazolidine,
N-(2′-hydroxypropyl)-2-phenyl-4,4-dimethyloxazolidine,
N-(2′-hydroxypropyl)-2,2,4,4-tetramethyloxazolidine,
N-(3′-hydroxypropyl)oxazolidine,
N-(3′-hydroxypropyl)-2-methyloxazolidine,
N-(3′-hydroxypropyl)-2-ethyloxazolidine,
N-(3′-hydroxypropyl)-2-isopropyloxazolidine,
N-(3′-hydroxypropyl)-2-propyloxazolidine,
N-(3′-hydroxypropyl)-2-phenyloxazolidine,
5N-(3′-hydroxypropyl)-2,2-dimethyloxazolidine,
N-(3′-hydroxypropyl)-4-methyloxazolidine,
N-(3′-hydroxypropyl)-2,4-dimethyloxazolidine,
N-(3′-hydroxypropyl)-2-ethyl-4-methyloxazolidine,
N-(3′-hydroxypropyl)-2-isopropyl-4-methyloxazolidine,
N-(3′-hydroxypropyl)-2-propyl-4-methyloxazolidine,
N-(3′-hydroxypropyl)-2-phenyl-4-methyloxazolidine,
N-(3′-hydroxypropyl)-2,2,4-trimethyloxazolidine,
N-(3′-hydroxypropyl)-5-methyloxazolidine,
N-(3′-hydroxypropyl)-2,5-dimethyloxazolidine,
N-(3′-hydroxypropyl)-2-ethyl-5-methyloxazolidine,
N-(3′-hydroxypropyl)-2-isopropyl-5-methyloxazolidine,
N-(3′-hydroxypropyl)-2-propyl-5-methyloxazolidine,
N-(3′-hydroxypropyl)-2-phenyl-5-methyloxazolidine,
N-(3′-hydroxypropyl)-2,2,5-trimethyloxazolidine,
N-(3′-hydroxypropyl)-4,4-methyloxazolidine,
N-(3′-hydroxypropyl)-2,4,4,4-trimethyloxazolidinde,
N-(3′-hydroxypropyl)-2-ethyl-4,4-dimethyloxazolidine,
N-(3′-hydroxypropyl)-2-isopropyl-4,4-dimethyloxazolidine,
N-(3′-hydroxypropyl)-2-propyl-4,4-dimethyloxazolidine,
N-(3′-hydroxypropyl)-2-phenyl-4,4-dimethyloxazolidine or
N-(3′-hydroxypropyl)-2,2,4,4-tetramethyloxazolidine.

Those especially preferred are N-(2′-hydroxyethyl)oxazolidine,
N-(2′-hydroxyethyl)-2-methyloxazolidine,
N-(2′-hydroxyethyl)-2-ethyloxazolidine,
N-(2′-hydroxyethyl)-2-isopropyloxazolidine,
N-(2′-hydroxyethyl)-2,2-dimethyloxazolidine,
N-(2′-hydroxypropyl)oxazolidine,
N-(2′-hydroxypropyl)-2-methyloxazolidine,
N-(2′-hydroxypropyl)-2-ethyloxazolidine,
N-(2′-hydroxypropyl)-2-isopropyloxazolidine,
N-(2′-hydroxypropyl)-2,2-dimethyloxazolidine, with particular preference being given to N-(2′-hydroxyethyl)oxazolidine,
N-(2′-hydroxyethyl)-2-isopropyloxazolidine, and
N-(2′-hydroxyethyl)-2,2-dimethyloxazolidine.

Compounds suitable as component d) are those having at least one isocyanate-reactive group and at least one actively dispersing group.

Such compounds are represented for example by the general formula
RG-R³-DG
where
RG is at least one isocyanate-reactive group,
DG is at least one actively dispersing group, and
R³ is an aliphatic, cycloaliphatic or aromatic radical containing 1 to 20 carbon atoms.

Examples of isocyanate-reactive groups RG are —OH, —SH, —NH₂ and —NHR⁴, in which R⁴ is as defined earlier but may be different from the radical used earlier on.

Examples of DG are —COOH, —SO₃H and —PO₃H and their anionic forms, with which any desired counterion may be associated, e.g., Li⁺, Na⁺, K⁺, Cs⁺, Mg²⁺, Ca²⁺, Ba²⁺, ammonium, methylammonium, dimethylammonium, trimethylammonium, ethylammonium, diethylammonium, triethylammonium, tributylammonium, di-iso-propylethylammonium, benzyldimethylammonium, monoethanolammonium, diethanolammonium, triethanolammonium, hydroxyethyldimethylammonium, hydroxyethyldiethylammonium, monopropanolammonium, dipropanolammonium, tripropanolammonium, piperidinium, piperazinium, N,N′-dimethylpiperazinium, morpholinium or pyridinium.

R³ can for example be methylene, 1,2-ethylene, 1,2-propylene, 1,3-propylene, 1,2-butylene, 1,4-butylene, 1,3-butylene, 1,6-hexylene, 1,8-octylene, 1,12-dodecylene, 1,2-phenylene, 1,3-phenylene, 1,4-phenylene, 1,2-naphthylene, 1,3-naphthylene, 1,4-naphthylene, 1,6-naphthylene, 1,2-cyclopentylene, 1,3-cyclopentylene, 1,2-cyclohexylene, 1,3-cyclohexylene or 1,4-cyclohexylene.

Component d) is preferably for example mercaptoacetic acid, mercaptopropionic acid, thiolactic acid, mercaptosuccinic acid, glycine, iminodiacetic acid, sarcosine, alanine, β-alanine, leucine, isoleucine, aminobutyric acid, hydroxyacetic acid, hydroxypivalic acid, lactic acid, hydroxysuccinic acid, hydroxydecanoic acid, dimethylolpropionic acid, dimethylolbutyric acid, ethylenediaminetriacetic acid, hydroxydodecanoic acid, hydroxyhexadecanoic acid, 12-hydroxystearic acid, aminonaphthalenecarboxylic acid, hydroxyethanesulfonic acid, hydroxypropanesulfonic acid, mercaptoethanesulfonic acid, mercaptopropanesulfonic acid, aminomethanesulfonic acid, taurine, aminopropanesulfonic acid, and their alkali metal, alkaline earth metal or ammonium salts, and with particular preference the abovementioned monohydroxycarboxylic and monohydroxysulfonic acids and also monoaminocarboxylic and monoaminosulfonic acids.

To prepare the dispersion the aforementioned acids, if not already in salt form, are fully or partly neutralized, preferably using alkali metal salts or amines, preferably tertiary amines.

Suitable component e) compounds are those which contain at least two isocyanate-reactive groups, examples being —OH, —SH, —NH₂ or —NHR⁵, in which R⁵ is as defined above.

Compounds preferred for possible use as components e) have 2-10 isocyanate-reactive groups, more preferably 2-6, very preferably 2-4, and in particular 2-3 isocyanate-reactive groups, preferably —OH or —NH₂, and very preferably —OH groups.

The compounds in question are, for example, polymers having a hydroxyl group content of from 0.1 to 20% by weight, preferably from 0.5 to 10% by weight. The number average molecular weight Mₙ of the polymers is preferably from 1000 to 100 000, more preferably from 2000 to 10 000. The polymers are preferably those composed of more than 50% by weight of C₁-C₂₀ alkyl (meth)acrylate, vinylaromatics having up to 20 carbon atoms, vinyl esters of carboxylic acids containing up to 20 carbon atoms, vinyl halides, nonaromatic hydrocarbons having 4 to 8 carbon atoms and 1 or 2 double bonds, unsaturated nitriles, and mixtures thereof. Particular preference is given to the polymers composed of more than 60% by weight of C₁-C₁₀-alkyl (meth)acrylates, styrene or mixtures thereof.

The polymers may additionally contain hydroxy-functional monomers in accordance with the above hydroxyl content and, where appropriate, further monomers, examples being ethylenically unsaturated acids, especially carboxylic acids, acid anhydrides or acid amides.

Examples of further polymers are polyesterols as obtainable by condensation of polycarboxylic acids, especially dicarboxylic acids, with polyols, especially diols.

Further suitable polymers include polyetherols, prepared by addition reaction of ethylene oxide, propylene oxide or butylene oxide with H-active components. Polycondensates formed from butanediol are also suitable.

The polymers can of course also be compounds having primary or secondary amino groups.

Particularly preferred components e) are diols or polyols, such as hydrocarbon diols having 2 to 20 carbon atoms, e.g., ethylene glycol, 1,2-propanediol, 1,3-propanediol, 1,1-dimethylethane-1,2-diol, 1,6-hexanediol, 1,10-decanediol, bis-(4-hydroxycyclohexane)isopropylidene, tetramethylcyclobutanediol, 1,2-, 1,3- or 1,4-cyclohexanediol, cyclooctanediol, norbornanediol, pinanediol, decalindiol, etc., their esters with short-chain dicarboxylic acids, such as adipic acid and cyclohexanedicarboxylic acid, their carbonates, prepared by reacting the diols with phosgene or by transesterification with dialkyl or diaryl carbonates, or aliphatic diamines, such as methylene- and isopropylidenebis(cyclohexylamine), piperazine, 1,2-, 1,3- or 1,4-diaminocyclohexane, 1,2-, 1,3- or 1,4-cyclohexanebis(methylamine), etc., dithiols or polyfunctional alcohols, secondary or primary amino alcohols, such as ethanolamine, diethanolamine, monopropanolamine, dipropanolamine, etc., or thioalcohols, such as thioethylene glycol.

Also conceivable are diethylene glycol, triethylene glycol, dipropylene glycol, tripropylene glycol, neopentyl glycol, pentaerythritol, 1,2- and 1,4-butanediol, 1,5-pentanediol, 2-methyl-1,5-pentanediol, 2-ethyl-1,4-butanediol, 1,2-, 1,3- and 1,4-dimethylolcyclohexane, glycerol, trimethylolethane, trimethylolpropane, trimethylolbutane, dipentaerythritol, ditrimethylolpropane, erythritol, and sorbitol, 2-aminoethanol, 3-amino-1-propanol, 1-amino-2-propanol or 2-(2-aminoethoxy)ethanol, bisphenol A, or butanetriol.

Likewise suitable are unsaturated polyetherols or polyesterols or polyacrylatepolyols having an average OH functionality from 2 to 10, and also polyamines, such as polyethyleneimine, for example, or polymers containing free amino groups and derived from poly-N-vinylformamide, for example.

Particularly suitable here are the cycloaliphatic diols, such as bis-(4-hydroxycyclohexane)isopropylidene, tetramethylcyclobutanediol, 1,2-, 1,3- or 1,4-cyclohexanediol, cyclooctanediol or norbornanediol, for example.

Compounds suitable as component f) are those having at least one isocyanate-reactive group. These can be, for example, monoalcohols, mercaptans or monoamines having 1 to 20 carbon atoms, e.g., methanol, ethanol, iso-propanol, n-propanol, n-butanol, iso-butanol, sec-butanol, tert-butanol, ethylene glycol monomethyl ether, ethylene glycol monoethyl ether, diethylene glycol monomethyl ether, diethylene glycol monoethyl ether, 1,3-propanediol monomethyl ether, 1,2-propanediol monoethyl ether, 1,2-propanediol monomethyl ether, n-hexanol, n-heptanol, n-octanol, n-decanol, n-dodecanol, 2-ethylhexanol, cyclopentanol, cyclohexanol, cyclooctanol, cyclododecanol, triethylene glycol monomethyl ether, triethylene glycol monoethyl ether, n-pentanol, stearyl alcohol, cetyl alcohol, lauryl alcohol, cyclpent-2-en-1-ol, cyclopent-3-en-1-ol, cyclohex-2-en-1-ol, allyl alcohol, methylamine, ethylamine, iso-propylamine, n-propylamine, n-butylamine, iso-butylamine, sec-butylamine, tert-butylamine, n-pentylamine, n-hexylamine, n-heptylamine, n-octylamine, n-decylamine, n-dodecylamine, 2-ethylhexylamine, stearylamine, cetylamine, laurylamine, dimethylamine, diethylamine, di-n-propylamine, di-iso-propylamine, di-n-butylamine, dihexylamine, dioctylamine, ethylmethylamine, iso-propylmethylamine, n-butylmethylamine, tert-butylmethylamine, iso-propylethylamine, n-butylethylamine, tert-butylethylamine, cyclopentylamine, cyclohexylamine, cyclooctylamine, cyclododecylamine, morpholine, piperidine, pyrrolidine, N-methylpiperazine, monoethanolamine, diethanolamine, monopropanolamine, dipropanolamine, methanethiol, ethanethiol, iso-propanethiol, n-propanethiol, n-butanethiol, iso-butanethiol, sec-butanethiol or tert-butanethiol.

As photoinitiators (C) it is possible to use those known to the skilled worker, such as those referred to in “Advances in Polymer Science”, Volume 14, Springer Berlin 1974 or in K. K. Dietliker, Chemistry and Technology of UV and EB Formulation for Coatings, Inks and Paints, Volume 3; Photoinitiators for Free Radical and Cationic Polymerization, P. K. T. Oldring (Ed.), SITA Technology Ltd, London.

Suitable examples include phosphine oxides, benzophenones, α-hydroxyalkyl aryl ketones, thioxanthones, anthraquinones, acetophenones, benzoins and benzoin ethers, ketals, imidazoles or ph enylglyoxylic acids, and mixtures thereof.

Phosphine oxides are for example monoacyl- or bisacylphosphine oxides, such as Irgacure® 819 (bis(2,4,6-trimethylbenzoyl)phenylphosphine oxide), as described for example in EP-A 7 508, EP-A 57 474, DE-A 196 18 720, EP-A 495 751 or EP-A 615 980, such as 2,4,6-trimethylbenzoyldiphenylphosphine oxide (Lucirin® TPO), ethyl 2,4,6-trimethylbenzoylphenylphosphinate or bis(2,6-dimethoxybenzoyl)-2,4,4-trimethylpentylphosphine oxide; benzophenones are for example benzophenone, 4-aminobenzophenone, 4,4′-bis(dimethylamino)benzophenone, 4-phenylbenzophenone, 4-chlorobenzophenone, Michler's ketone, o-methoxybenzophenone, 2,4,6-trimethylbenzophenone, 4-methylbenzophenone, 2,4-dimethylbenzophenone, 4-isopropylbenzophenone, 2-chlorobenzophenone, 2,2′-dichlorobenzophenone, 4-methoxybenzophenone, 4-propoxybenzophenone or 4-butoxybenzophenone,
α-hydroxyalkyl aryl ketones are for example 1-benzoylcyclohexan-1-ol (1-hydroxycyclohexyl phenyl ketone), 2-hydroxy-2,2-dimethylacetophenone (2-hydroxy-2-methyl-1-phenylpropan-1-one), 1-hydroxyacetophenone, 1-[4-(2-hydroxyethoxy)phenyl]-2-hydroxy-2-methyl-1-propan-1-one or polymer containing 2-hydroxy-2-methyl-1-(4-isopropen-2-ylphenyl)propan-1-one in copolymerized form (Esacure® KIP 150);
xanthones and thioxanthones are for example 10-thioxanthenone, thioxanthen-9-one, xanthen-9-one, 2,4-dimethylthioxanthone, 2,4-diethylthioxanthone, 2,4-diisopropylthioxanthone, 2,4-dichlorothioxanthone or chloroxanthenone;
anthraquinones are for example β-methylanthraquinone, tert-butylanthraquinone, anthraquinonecarboxylic esters, benz[de]anthracen-7-one, benz[a]anthracen-7,12-dione, 2-methylanthraquinone, 2-ethylanthraquinone, 2-tert-butylanthraquinone, 1-chloroanthraquinone or 2-amylanthraquinone;
acetophenones are for example acetophenone, acetonaphthoquinone, valerophenone, hexanophenone, α-phenylbutyrophenone, p-morpholinopropiophenone, dibenzosuberone, 4-morpholinobenzophenone, p-diacetylbenzene, 4′-methoxyacetophenone, α-tetralone, 9-acetylphenanthrene, 2-acetylphenanthrene, 3-acetylphenanthrene, 3-acetylindole, 9-fluorenone, 1-indanone, 1,3,4-triacetylbenzene, 1-acetonaphthone, 2-acetonaphthone, 2,2-dimethoxy-2-phenylacetophenone, 2,2-diethoxy-2-phenylacetophenone, 1,1-dichloroacetophenone, 1-hydroxyacetophenone, 2,2-diethoxyacetophenone, 2-methyl-1-[4-(methylthio)phenyl]-2-morpholinopropan-1-one, 2,2-dimethoxy-1,2-diphenylethan-2-one or 2-benzyl-2-dimethylamino-1-(4-morpholinophenyl)butan-1-one;
benzoins and benzoin ethers are for example 4-morpholinodeoxybenzoin, benzoin, benzoin isobutyl ether, benzoin tetrahydropyranyl ether, benzoin methyl ether, benzoin ethyl ether, benzoin butyl ether, benzoin isopropyl ether or 7H-benzoin methyl ether; and
ketals are for example acetophenone dimethyl ketal, 2,2-diethoxyacetophenone, or benzil ketals, such as benzil dimethyl ketal.

Phenylglyoxylic acids are described for example in DE-A 198 26 712, DE-A 199 13 353 or WO 98/33761.

Photoinitiators which can be used as well are for example benzaldehyde, methyl ethyl ketone, 1-naphthaldehyde, triphenylphosphine, tri-o-tolylphosphine or 2,3-butaned-ione.

Typical mixtures include for example
2-hydroxy-2-methyl-1-phenylpropan-2-one and 1-hydroxycyclohexyl phenyl ketone,
bis(2,6-dimethoxybenzoyl)-2,4,4-trimethylpentylphosphine oxide and 2-hydroxy-2-methyl-1-phenylpropan-1-one, benzophenone and 1-hydroxycyclohexyl phenyl ketone,
bis(2,6-dimethoxybenzoyl)-2,4,4-trimethylpentylphosphine oxide and 1-hydroxycyclohexyl phenyl ketone,
2,4,6-trimethylbenzoyldiphenylphosphine oxide and
2-hydroxy-2-methyl-1-phenylpropan-1-one,
2,4,6-trimethylbenzophenone and 4-methylbenzophenone or
2,4,6-trimethylbenzophenone, and 4-methylbenzophenone and
2,4,6-trimethylbenzoyldiphenylphosphine oxide.

As further typical coatings additivies (D) it is possible for example to use antioxidants, stabilizers, activators (accelerators), fillers, pigments, dyes, antistats, flame retardants, thickeners, thixotropic agents, surface-active agents, viscosity modifiers, plasticizers or chelating agents.

As accelerators for the thermal aftercure it is possible to use for example tin octoate, zinc octoate, dibutyltin laurate or diazabicyclo[2.2.2]octane.

In addition it is possible to add one or more photochemically and/or thermally activable initiators, examples being potassium peroxodisulfate, dibenzoyl peroxide, cyclohexanone peroxide, di-tert-butyl peroxide, azobis-iso-butyronitrile, cyclohexylsulfonyl acetyl peroxide, di-iso-propyl percarbonate, tert-butyl peroctoate, and benzpinacol, and also, for example, those thermally activable initiators with a half-life at 80° C. of more than 100 hours, such as di-t-butyl peroxide, cumene hydroperoxide, dicumyl peroxide, t-butyl perbenzoate, silylated pinacols, such as those available commercially under the trade name ADDID 600 from Wacker, or hydroxyl-containing amine N-oxides, such as 2,2,6,6-tetramethylpiperidine-N-oxyl, 54-hydroxy-2,2,6,6-tetramethylpiperidine-N-oxyl, etc.

Other examples of suitable initiators are described in “Polymer Handbook”, 2^{nd} Ed., Wiley & Sons, New York.

Suitable thickeners besides free radically (co)polymerized (co)polymers include customary organic and inorganic thickeners such as hydroxymethylcellulose or bentonite.

As chelating agents it is possible for example to use ethylenediamineacetic acid and its salts and also β-diketones.

Suitable fillers include silicates, e.g. silicates obtainable by hydrolysis of silicon tetrachloride, such as Aerosil® from Degussa, siliceous earth, talc, aluminum silicates, magnesium silicates, calcium carbonates, etc.

Suitable stabilizers include typical. UV absorbers such as oxanilides, triazines, and benzotriazole (the latter obtainable as Tinuvin® grades from Ciba-Spezialitatenchemie), and benzophenones. These can be used alone or together with suitable free radical scavengers, examples of which are sterically hindered amines such as 2,2,6,6-tetramethylpiperidine, 2,6-di-tert-butylpiperidine or derivatives thereof, e.g., bis-(2,2,6,6-tetramethyl-4-piperidyl) sebacate. Stabilizers are used normally in amounts of from 0.1 to 5.0% by weight, based on the solid components present in the formulation.

The polyurethanes (A) of the invention are obtained by reacting components a), b), and c) with one another.

In such a reaction the molar composition a):b):c) for each 3 mol of reactive isocyanate groups in a) is generally as follows:
b) 0.1-2.9, preferably 0.5-2.8, more preferably 1.0-2.5, and especially 1.5-2.5 mol of isocyanate reactive groups and
c) 2.9-0.1, preferably 0.2-2.5, more preferably 0.5-2.0, and especially 0.5-1.5 mol of isocyanate-reactive groups.

Following reaction of components a), b) and c) the polyurethane (A) may still contain free or, where appropriate, blocked isocyanate groups, although preferably more than 30% of the isocyanate groups present in a) prior to the reaction have undergone reaction, more preferably more than 50%, very preferably more than 60%, and in particular more than 65%.

When the polyurethanes are used in aqueous systems it is preferred for substantially all the isocyanate groups present to have undergone reaction.

In one preferred embodiment, particularly when the polyurethanes of the invention are used in aqueous dispersions, polyurethanes of the invention can include d), e) and/or f) as further synthesis components in the following amounts (per mole of reactive isocyanate group in the polyurethane (A)):
d) 1-30 mol %, preferably 2-20 mol %, more preferably 3-15 mol %, and especially 5-10 mol % of isocyanate-reactive groups,
e) 0-50 mol %, preferably 5-40 mol %, more preferably 10-30 mol %, and especially 15-25 mol % of isocyanate-reactive groups, and/or
f) 0-50 mol %, preferably 5-40 mol %, very preferably 10-30 mol %, and especially 15-25 mol % of isocyanate-reactive groups.

The formation of the adduct from isocyanato-functional compound and the compound containing groups that are reactive toward isocyanate groups is generally accomplished by mixing the components in any order, where appropriate at elevated temperature.

It is preferred to add the compound containing isocyanate-reactive groups to the isocyanato-functional compound, preferably in two or more steps.

Particular preference is given to introducing the isocyanato-functional compound as an initial charge and adding the compounds containing isocyanate-reactive groups. In particular first of all the isocyanato-functional compound a) is introduced, then b) and subsequently c) are added, or first of all the isocyanato-functional compound a) is introduced, then c) and subsequently b) are added. After that it is possible if desired to add further components which are wanted.

In another embodiment it is possible to prepare adducts (A1) from a) and b), and where appropriate d), e) and/or f), and adducts (A2) from a) and c), and also where appropriate d), e) and/or f), separately from one another and to react the components (A1) and (A2) thus obtainable at a later time, with the formation of adducts (A), for the purpose for example of preparing a coating formulation or dispersion.

Generally speaking, the reaction is conducted at temperatures between 0 and 150° C., preferably between 20 and 130° C., more preferably between 25 and 120° C., and in particular between 40 and 100° C.

The reaction is generally performed in bulk (without solvent), in solution or in dispersion, preferably under atmospheric pressure.

Preference is given here to operating under water-free conditions.

Water-free means that the water content in the reaction system is not more than 5% by weight, preferably not more than 3% by weight, and more preferably not more than 1% by weight.

The reaction is preferably conducted in the presence of at least one suitable inert gas, e.g., nitrogen, argon, helium, carbon dioxide or the like.

The reaction can also be conducted in the presence of an inert solvent, e.g., acetone, iso-butyl methyl ketone, ethyl methyl ketone, toluene, xylene, butyl acetate or ethoxyethyl acetate.

Preferably, however, the reaction is conducted in the absence of a solvent.

The reaction is normally ended when the groups in the reaction mixture that are reactive with NCO groups have undergone virtually quantitative reaction. Excess monomeric isocyanate is then removed by distillation under reduced pressure, preferably down to a level below 1% by weight.

The NCO content as per DIN 53185 of the monomer-free polyurethanes (A) of the invention is preferably from 25 to 0% by weight.

Other reaction parameters are part of the skilled worker's general knowledge and can be chosen for example in the manner described in EP-A 585835, EP-A 496208, EP-A 69866, in U.S. Pat. Nos. 5,124,427, 5,258,482, and 5,290,902, and also DE-A-4015155 for the preparation of other biurets, allophanates, and isocyanurates.

Normally the monomers are reacted in the presence of a catalyst, preferably in amounts of from 10 to 5000 ppm by weight based on the amount of isocyanates employed.

Suitable catalysts include those widely known to catalyze the formation of adducts from isocyanate groups, i.e., for example, the quaternary ammonium hydroxides described in EP-A-649 866, such as N,N,N-trimethyl-N-(2-hydroxypropyl)ammonium hydroxide, or the quaternary ammonium carboxylates known from EP-A-182 203, such as N,N,N-trimethyl-N-(2-hydroxypropyl)ammonium 2-ethylhexanoate, or organozinc compounds known to catalyze the formation of allophanates, such as zinc acetylacetonate or zinc 2-ethylcaproate.

As an alternative other organometallic compounds are used, viz. those having at least one covalent metal-carbon bond, for catalyst purposes, examples being organic compounds of zirconium and bismuth.

The polyaddition of the abovementioned monomers for preparing the polyurethane formulation of the invention can take place with particular preference in the presence of cesium salts, as described in the older German patent application of Dec. 12, 2001 with the application number 10161156.0. Preferred cesium salts are compounds which use the following anions: F⁻, Cl⁻, ClO⁻, ClO₃⁻, ClO₄⁻, Br⁻, I⁻, IO₃⁻, CN⁻, OCN³¹, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂₋, H₂PO₄⁻, HPO₄²⁻, PO₄³⁻, P₂O₇⁴⁻, (OCₙH₂ₙ₊₁)⁻, (CₙH₂ₙ₋₁O₂)⁻, (CₙH₂ₙ₋₃O₂)⁻, and (Cₙ₊₁H₂ₙ₋₂O₄)²⁻, in which n stands for the numbers 1 to 20.

Particularly preferred are cesium carboxylates in which the anion conforms to the formulae (CₙH₂ₙ₋₁O₂)⁻ and also (Cₙ₊₁H₂ₙ₋₂O₄)²⁻, with n being from 1 to 20. Especially preferred cesium salts have monocarboxylate anions of the general formula (CₙH₂ₙ₋₁O₂)⁻, in which n stands for the numbers 1 to 20. In this context, particular mention may be made of the formate, acetate, propionate, hexanoate and 2-ethylhexanoate.

The cesium salts are used in amounts of from 0.01 to 10 mmol of cesium salt per kg of solvent-free batch. Preferably they are used in amounts of from 0.05 to 2 mmol of cesium salt per kg of solvent-free batch.

The cesium salts can be added to the batch in solid form but are preferably added in dissolved form. As solvents, polar aprotic solvents or else protic solvents are suitable. Particularly suitable, in addition to water, are also alcohols; especially suitable are polyols, such as are also otherwise used as building blocks for polyurethanes, such as ethanediols, propanediols, and butanediols, for example. The use of the cesium salts allows the polyaddition to be conducted under the standard conditions.

The progress of the reaction of polyurethane formation is appropriately monitored by gel permeation chromatography (GPC) or by determining the NCO content of the reaction mixture.

The reaction is normally ended when the starting compounds that are reactive with isocyanate groups have undergone virtually complete reaction, i.e., are no longer detectable by GPC.

The normal way of ending the reaction is to add deactivators.

Examples of suitable deactivators include organic and inorganic acids, the corresponding acid halides, and alkylating agents. By way of example mention may be made of phosphoric acid, monochloroacetic acid, dodecylbenzenesulfonic acid, benzoyl chloride, dimethyl sulfate, and, preferably, dibutyl phosphate and also di-2-ethylhexyl phosphate. The deactivators can be used in amounts of from 1 to 200 mol %, preferably from 20 to 100 mol %, based on the moles of catalyst.

Especially preferred polyurethanes (A) are those having an allophanate content as determinable by gel permeation chromatography of from 0.5 to 100 mol %, very preferably from 5 to 65 mol %, and in particular from 10 to 50 mol %, based on the allophanate molecule with the lowest molecular mass.

Very much preferred polyurethanes (A) contain at least one of the following compounds of the formula (II), 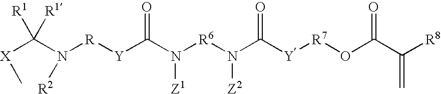
or higher homologs thereof
where
R, R¹, R¹′, R², X, and Y are as defined above,
Y′ can be as defined for Y but can also be different,
R⁶ and R⁷ each independently are a divalent organic aliphatic, cycloaliphatic or aromatic radical containing 2 to 20 carbon atoms and unsubstituted or substituted by functional groups, aryl, alkyl, aryloxy, alkyloxy, halogen, heteroatoms and/or heterocycles,
R⁸ is hydrogen, methyl, ethyl or hydroxymethyl, and
Z¹ and Z² can be identical or different and independently of one another can be hydrogen or —(CO)—NH—R⁶—NCO.
R⁶ radicals are for example the divalent radicals derived from the abovementioned diisocyanates, such as 1,4-butylene, 1,6-hexylene, 1,8-octylene, 1,10-decylene, 1,12-dodecylene, 1,14-tetradecylene, tetramethylxylylene, 2,4,4-trimethylhex-1,6-ylene, 2,2,4,4-tetramethylhex-1,6-ylene, 1,4-, 1,3- or 1,2-cyclohexylene, di(cyclohexyl)methan-4,4′-ylene, di(cyclohexyl)methan-2,4′-ylene, 3,3,5,5-tetramethylcyclohex-1,5(1′)-ylene, 1,4-dimethylcyclohexan-1(1′),4(1″)-ylene, 1,3-dimethylcyclohexan-1(1′),3(1″)-ylene, 1-methylcyclohex-2,4- or -2,6-ylene, 2,4- or 2,6-tolylene, m- or p-xylylene, diphenylmethan-2,4′-ylene, diphenylmethan-4,4′-ylene, 1,3- or 1,4-phenylene, 1-chloro-2,4-phenylene, 1,5-naphthylene, 4,4′-diphenylene, 3,3′-dimethyldiphen-4,4′-ylene or 3-methyldiphenylmethan-4,4′-ylene.

Preferably R⁶ is 1,6-hexylene or 3,3,5,5-tetramethylcyclohex-1,5(1′)-ylene and with particular preference it is 1,6-hexylene.

R⁷ is for example 1,2-ethylene, 1,2-propylene, 1,3-propylene, 2-methyl-1,3-propylene, 2,2-dimethyl-1,3-propylene, 2-ethyl-1,3-propylene, 2-hydroxy-1,3-propylene, 2-hydroxymethyl-2-ethyl-1,3-propylene, 2,2-bis(hydroxymethyl)-1,3-propylene, 1,4-butylene, 1,6-hexylene or 2-ethyl-1,3-hexylene.

Preferably R⁷ is 1,2-ethylene, 1,4-butylene or 1,6-hexylene, more preferably 1,2-ethylene or 1,4-butylene and very preferably 1,2-ethylene.
Y′ is preferably oxygen (—O—).
R⁸ is preferably hydrogen.
n is preferably 2.

The polyurethanes of the invention are particularly suitable as binders, in for example coating compositions, surface coating materials or paints.

The polyurethanes and polyurethane dispersions of the invention can be used with preference as coating compositions. For that purpose components (C) and, where appropriate, (D) are added to them where necessary.

Based on the overall weight the finished polyurethane dispersion can contain 0-10% by weight of (C), preferably 1-8% by weight, more preferably 2-7% by weight, and in particular 3-0.5% by weight.

Based on the overall weight the finished dispersion can contain 0-50% by weight of components (D), preferably 5-40% by weight, more preferably 10-30% by weight, and especially 15-25% by weight.

The coating of the substrates is in accordance with customary methods which are known to the skilled worker, in which at least one coating formulation or dispersion of the invention is applied to the target substrate in the desired thickness and the volatile constituents of the dispersions are removed, where appropriate with heating. This operation can be repeated one or more times if desired. Application to the substrate may take place in a known way, for example, by spraying, trowelling, knifecoating, brushing, rolling, roller coating, pouring, laminating, injection backmolding or coextruding. The coating thickness is generally in a range from about 3 to 1000 g/m² and preferably from 10 to 200 g/m².

Disclosed in addition is a method of coating substrates which involves adding further typical coatings additives and thermally curable resins where appropriate to the polyurethane of the invention, to the polyurethane dispersions of the invention or to coating formulations of the invention, applying the resultant systems to the substrate, and drying them where appropriate, and curing them with electron beams or by UV exposure under an oxygen-containing atmosphere or preferably under inert gas, where appropriate at temperatures up to the level of the drying temperature, and subsequently subjecting them to thermal treatment at temperatures up to 160° C., preferably between 60 and 160° C.

The method of coating substrates can also be conducted such that application of the polyurethanes or polyurethane dispersions or coating formulations of the invention is followed first by their thermal treatment at temperatures up to 160° C., preferably between 60 and 160° C., and subsequently by curing with electron beams or by UV exposure under oxygen or preferably under inert gas.

Curing of the films formed on the substrate can if desired take place by means of heat alone. Generally speaking, however, the coatings are cured both by exposure to high-energy radiation and thermally.

In addition to or instead of the thermal cure, curing may also be effected by means of NIR radiation, which here means electromagnetic radiation in the wavelength range from 760 nm to 2.5 μm, preferably from 900 to 1500 nm.

If two or more coats of the coating composition are applied one above another it is possible if desired for each coating operation to be followed by an NIR, thermal and/or radiation cure.

Examples of suitable radiation sources for the radiation cure include low pressure mercury lamps, medium pressure mercury lamps, and high pressure mercury lamps, and also fluorescent tubes, pulsed lamps, metal halide lamps, electronic flash devices, which allow radiation curing without a photoinitiator, or excimer sources. The radiation cure is effected by exposure to high-energy radiation, i.e., UV radiation or daylight, preferably light in the wavelength (λ) range of 200 to 700 nm, more preferably 200 to 500 nm, and very preferably 250 to 400 nm, or by irradiation with high-energy electrons (electron beams; 150 to 300 keV). Radiation sources used are for example high pressure mercury vapor lamps, lasers, pulsed lamps (flashlights), halogen lamps or excimer emitters. The radiation dose normally sufficient for crosslinking in the case of UV curing is in the range from 80 to 3000 mJ/cm².

It is of course also possible to use two or more radiation sources for curing, e.g., two to four.

The sources may also each emit in different wavelength ranges.

Where appropriate, irradiation can also be carried out in the absence of oxygen, e.g., under an inert gas atmosphere. Suitable inert gases include preferably nitrogen, noble gases, carbon dioxide, or combustion gases. Irradiation may also be performed with the coating composition covered with transparent media.

Examples of transparent media are polymer films, glass or liquids, e.g. water. Particular preference is given to irradiation in the manner described in DE-A 199 57 900.

The invention further provides a method of coating substrates which comprises
i) coating a substrate with a coating formulation or dispersion as described above,
ii) removing volatile constituents of the coating formulation or dispersion in order to form a film, under conditions in which the initiator (C) as yet essentially forms no free radicals,
iii) if desired, subjecting the film formed in step ii) to high-energy radiation, in the course of which the film is precured, and subsequently machining the article coated with the precured film, if desired, or contacting the surface of the precured film with another substrate, and
iv) subjecting the film to a final thermal cure.

Steps iv) and iii) may also be carried out in the opposite order, i.e., the film can be cured first thermally and then with high-energy radiation.

The coating formulations and dispersions of the invention are particularly suitable for the coating of substrates such as wood, paper, textile, leather, nonwoven, plastics surfaces, glass, ceramic, mineral building materials, such as cement blocks and fiber cement slabs, or coated or uncoated metals, preferably for the coating of plastics or metals, particularly in the form of films or foils.

With particular preference the dispersions or coating formulations of the invention are suitable as or in exterior coatings, i.e., in those applications where they are exposed to daylight, preferably on buildings or parts of buildings, interior coatings, traffic markings, coatings on vehicles or aircraft. The coating formulations or dispersions of the invention are employed in particular as or in automotive clearcoat and topcoat material(s).

The curing of the polyurethanes of the invention may for example involve the following mechanisms:
mechanism 1, rapid: curing of double bonds with the aid of high-energy radiation
mechanism 2, slow: curing of the isocyanate groups by way of atmospheric moisture
mechanism 3, rapid: capped amines react with atmospheric moisture, amine (and possibly alcohol as well) is released
mechanism 4, very rapid: curing of NCO groups with amine
mechanism 5, rapid: curing of NCO groups with alcoholic hydroxyl groups
mechanism 6, rapid: curing of the double bond with amine (Michael addition)

Only mechanisms 1 and 2 are present in the case of conventional dual cure systems. In the case of the products according to the invention the slow reaction of NCO with water is significantly accelerated by the prior reaction of the capped amine with water and the subsequent reaction of NCO with amine. The amine produced also opens up the possibility of reaction with the double bond.

A further advantage is that the films become harder as a result of the purposive formation of ureas.

The examples below are intended to illustrate the properties of the invention though without restricting it.

### EXAMPLES

In this specification all parts unless specified otherwise are to be understood as parts by weight.

The viscosities were determined using a Rheolab MC 1 System, Z4 DIN, from Paar Physica at 23° C.

### Example 1

0.5 mol of hexamethylene diisocyanate (HDI, i.e., 1 mol of NCO groups) in solution in 500 ml of dried methyl ethyl ketone was introduced as an initial charge under nitrogen and 0.5 mol of hydroxyethyl acrylate and 0.5 mol of 1-hydroxyethyl-2-isopropyl-1,3-oxazolidine (prepared in accordance with DE-A 22 45 636) were added. The mixture was heated to 70° C. and 200 ppm (based on HDI) of dibutyltin dilaurate were added. The reaction mixture was stirred at 70° C. for 1 hour and the solvent was then removed on a rotary evaporator. The melting point of the solid, NCO-free product was 70-80° C.

### Example 2

Hexamethylene diisocyanate (HDI) was introduced as an initial charge under nitrogen and the amount of hydroxyalkyl (meth)acrylate specified in Table 1 was added. The mixture was heated to 80° C. and 200 ppm by weight (based on diisocyanate) of the catalyst N,N,N-trimethyl-N-(2-hydroxypropyl)ammonium 2-ethylhexanoate were added. The temperature rose slowly to 120° C. The reaction mixture was left to react at this temperature until the mixture had the NCO content specified in Table 1, at which point the reaction was stopped by adding 250 ppm by weight (based on diisocyanate) of di-2-ethylhexyl phosphate. The reaction mixture was subsequently freed from unreacted HDI in a thin film evaporator at 1350C and 2.5 mbar.

End product data are included in Table 1.

TABLE 1

| | | | | | NCO con- | |
|---|---|---|---|---|---|---|
| | | | Amount | NCO con- | tent af- | Vis- |
| | | Hydroxy- | based on | tent of | ter dis- | cosity |
| Prod- | Iso- | alkyl | isocya- | mixture | tillation | at |
| uct | cya- | (meth)acry- | nate | (% by | (% by | 23° C. |
| No. | nate | late | (mol %) | weight) | weight) | (mPas) |
| 1 | HDI | HEA | 5 | 40.8 | 20.1 | 520 |
| 2 | HDI | HEA | 10 | 39.0 | 18.5 | 310 |
| 3 | HDI | HEA | 15 | 35.6 | 17.4 | 290 |
| 4 | HDI | HEA | 20 | 33.3 | 16.3 | 260 |
| 5* | HDI | HEA | 20 | 32.0 | 15.1 | 1,070 |
| 6 | HDI | HEA | 35 | 18.5 | 13.0 | 5,530 |
| 7 | HDI | HEA | 50 | 16.8 | 11.8 | 1,640 |
| 8 | HDI | HEMA | 30 | 23.2 | 14.2 | 1,290 |

Abbreviations:
HDI = Hexamethylene diisocyanate
HEA = Hydroxyethyl acrylate
HEMA = Hydroxyethyl methacrylate
*longer reaction time than for product 4

### Example 3

200 g of product 4 from Example 2 with an NCO content of 16.3% were introduced as an initial charge under nitrogen and heated to 60° C. and 123 g of 1-hydroxyethyl-2-isopropyl-1,3-oxazolidine were added over the course of 30 minutes. The reaction mixture was left to react at this temperature for 1 hour. The end product (product 9) after cooling had a viscosity at 23° C. of 720 mPas.

### Example 4

In the first stage of the reaction an HDI/HEA adduct as in product 5 from Table 1 is prepared. In the subsequent stage it is reacted with 1-hydroxyethyl-2-isopropyl-1,3-oxazolidine in accordance with the following procedure:
2 drops of dibutyltin dilaurate (in 100% form) were added to 556.3 g of HDI/HEA adduct (product 5 from Table 1) and the mixture was heated to 60° C. Then slowly over the course of 30 minutes 1-hydroxyethyl-2-isopropyl-1,3-oxazolidine (30, 40 or 50 mol % based on the analytical NCO value determined in accordance with DIN 53185) was added. Stirring was continued at 60° C. for approximately 1 hour.

End product data are included in Table 2.

TABLE 2

| | | Oxazoli- | | |
|---|---|---|---|---|
| | | dine | | |
| | HEA/HDI | (mol %) | NCO con- | |
| | adduct | in terms | tent | |
| Product | Product from | of NCO | (% by | Viscosity at |
| No. | Ex. 2 | content | weight) | 23° C. (mPas) |
| 10 | 5 | 30 | 9.0 | 9 110 |
| 11 | 5 | 40 | 7.4 | 16 800 |
| 12 | 5 | 50 | 5.9 | 23 200 |
| 12b | 5 | 100 | 0 | >30 000 |

### Example 5

Hexamethylene diisocyanate (HDI) was introduced as an initial charge under nitrogen and the amounts of hydroxyethyl acrylate and 1-(2′-hydroxyethyl)-2-isopropyl-1,3-oxazolidine specified in Table 3 were added. The mixture was heated to 80° C. and 200 ppm by weight (based on diisocyanate) of the catalyst N,N,N-trimethyl-N-(2-hydroxypropyl)ammonium 2-ethylhexanoate were added. The mixture was allowed to react at this temperature for 30 minutes, at which point the reaction was stopped by adding 250 ppm by weight (based on diisocyanate) of di-2-ethylhexyl phosphate. The reaction mixture was subsequently freed from unreacted HDI in a thin film evaporator at 135° C. and 2.5 mbar.

End product data are included in Table 3.

TABLE 3

| | HEA, | Oxazolidine, | |
|---|---|---|---|
| | amount based on | amount based on | Viscosity |
| Product | isocyanate | isocyanate | at 23° C. |
| No. | (mol %) | (mol %) | (mPas) |
| 13 | 10 | 10 | 730 |
| 14 | 15 | 15 | 1150 |

### Example 6

2000 g of hexamethylene diisocyanate (HDI) were introduced as initial charge under nitrogen and reacted with 20 mol % of N-(2-hydroxyethyl)-2-isopropyl-1,3-oxazolidine to give the allophanate. For this the mixture was heated to 80° C., 0.4 g of the catalyst DABCO TMR 1 (trade name of Air Products, N-(2-hydroxypropyl)trimethylammonium 2-ethylhexanoate) was added, and reaction was allowed to continue at this temperature until the mixture had an NCO content of 39-41% by weight, at which point reaction was stopped by adding 0.4 g of di-2-ethylhexyl phosphate. To remove monomeric HDI the reaction mixture was subsequently distilled in a thin film evaporator at an oil temperature of 165° C. and 2.5 mbar. The residual HDI monomer content of the end product was at this point under 0.5% by weight. The viscosity was 1700 mPas (product 15).

In the subsequent coating formulation the HDI/oxazolidine allophanate obtained (product 15) was mixed with product 5 from Table 1.

End product data are included in Table 4.

TABLE 4

| | Amount of | Amount of |
|---|---|---|
| Product | product 5 | product 15 |
| No. | (mol %) | (mol %) |
| 16 | 50 | 50 |
| 17 | 33 | 67 |

The products according to the invention were cured with atmospheric moisture or with UV irradiation with an atmospheric moisture aftercure. Coating mixtures of relatively high viscosity were diluted to 500 mPas using butyl acetate (BuAc). The coating materials were drawn down onto glass or metal sheet using film-drawing frames.

Test Methods:

pendulum damping (PD, in number of swings): coating on glass substrate (DIN 53157) with a dry coating film thickness of about 30 μm in the case of air curing and about 50 μm in the case of UV curing
Erichsen cupping (EC; DIN 53156, in mm of indentation): coating material on Bonder panel 132 (dimensions 190×105×1 mm from Chemetall): coating film thickness 25 to 30 μm
adhesion with cross-cut (Awc; DIN 53151, in ratings): coating material on Bonder panel 132 (dimensions 190×105×1 mm from Chemetall), dry coating film thickness 25 to 30 μm
   UV Irradiation:

The films, flashed off where appropriate at room temperature to remove solvent, are irradiated 5 times under an IST high pressure mercury lamp (120 W/cm) with a belt speed of 10 m/min.

TABLE 5
Curing without UV

| | Urethane acrylate | | | | | | |
|---|---|---|---|---|---|---|---|
| | Laromer ® LR 8987 | C2 | 1 from | 2 from | 3 from | 4 from | 8 from |
| Product | (BASF AG) | (comparative) | Table 1 | Table 1 | Table 1 | Table 1 | Table 1 |
| Viscosity | 4 000 | 12 300 | 520 | 310 | 290 | 260 | 2,920 |
| (mPas) | | | | | | | |
| NCO value | 0 | 12.8 | 20.1 | 18.5 | 17.4 | 16.7 | 15.8 |
| (mg KOH/g) | | | | | | | |
| Coating | 50 p product | 50 p product | 50 p product | 50 p product | 50 p product | 50 p product | 50 p product |
| material | 8 p BuAc | 8 p BuAc | 1.5 p BuAc | 0.5 p DBTL | 0.5 p DBTL | 0.5 p DBTL | 5.6 p BuAc |
| formula | 0.5 p DBTL | 0.5 p DBTL | 0.5 p DBTL | 10% strength | 10% strength | 10% strength | 0.5 p DBTL |
| | 10% strength | 10% strength | 10% strength | in BuAc | in BuAc | in BuAc | 10% strength |
| | in BuAc | in BuAc | in BuAc | | | | in BuAc |
| PD after 24 h | not curable | 32 | 29 | 23 | 24 | 25 | 25 |
| PD after 2 d | | | 105 | 44 | 30 | 29 | 56 |
| PD after 5 d | | | 142 | 54 | 32 | 30 | 61 |
| PD after 7 d | | 30 | 138 | 49 | 32 | 31 | 68 |
| PD after 14 d | | | 138 | 49 | 32 | 31 | |
| EC after 24 h | | | 9 | 9 | 9 | 9 | 6.3 |
| EC after 7 d | | | 8.5 | 9 | 9 | 9 | 6.4 |

Abbreviations:
p: parts
DBTL: dibutyltin dilaurate
C2: Roskydal ® UA VP LS 2337 from Bayer, urethane acrylate based on HDI isocyanurate

Result:

The allophanato acrylates cure without irradiation under the effect of atmospheric moisture to give tack-free films. The films are highly flexible.

TABLE 6
Curing with UV

| | Urethane acrylate | C2 | 1 from | 2 from | 3 from | 4 from |
|---|---|---|---|---|---|---|
| Product | Laromer LR 8987 | (comparative) | Table 1 | Table 1 | Table 1 | Table 1 |
| Viscosity | 4 000 | 12 300 | 520 | 310 | 290 | 260 |
| (mPas) | | | | | | |
| NCO value | 0 | 12.8 | 20.1 | 18.5 | 17.4 | 16.7 |
| (mg KOH/g) | | | | | | |
| Coating | 50 p product | 50 p product | 50 p product | 50 p product | 50 p product | 50 p product |
| material | 8 p BuAc | 14.5 p BuAc | 1.5 p BuAc | 2 p Irgacure 184 | 2 p Irgacure 184 | 2 p Irgacure 184 |
| formula | 2 p Irgacure 184 | 2 p Irgacure 184 | 2 p Irgacure 184 | | | |
| PD after 24 h | 128 | 42 | 46 | 69 | 71 | 63 |
| PD after 7 d | 129 | 139 | 146 | 144 | 144 | 143 |
| EC after 24 h | 3.8 | 8.5 | 9 | 9 | 9 | 9 |
| EC after 7 d | 3.7 | 4.5 | 3.9 | 4 | 4 | 4, 4 |
| AwC after 24 h | 5 | 0 | 0 | 0 | 0 | 0 |
| AwC after 7 d | 5 | 1 | 1 | 1.5 | 0.5 | 1 |

Irgacure ® 184 was obtained from Ciba Spezialitätenchemie.

Result:

The low viscosity, allophanate based isocyanates display curing characteristics similar to those of the higher viscosity urethane acrylate C2. Course of curing, flexibility, and adhesion to metal are comparably good. After UV irradiation the allophanato acrylates have cured to a tack-free state. Under the effect of atmospheric moisture there is a sharp increase in cure.

The urethane acrylate (Laromer) acquires its ultimate properties immediately following irradiation. The adhesion to different substrates, however, is much poorer.

1. A polyurethane (A) comprising
a) at least one organic diisocyanate or polyisocyanate,
b) at least one compound comprising at least one isocyanate-reactive group and at least one free-radically polymerizable unsaturated group and/or cationically polymerizable group,
c) at least one compound comprising at least one isocyanate-reactive group and at least one capped amino group and having a molecular weight below 1000 g/mol,
d) if desired, at least one compound containing comprising at least one isocyanate-reactive group and at least one actively dispersing group,
e) if desired, at least one compound comprising at least two isocyanate-reactive groups, and
f) if desired, compounds other than a) to d) comprising at least one isocyanate-reactive group, the allophanate fraction being 5 to 65 mol % based on the lowest molecular weight allophanate molecule.

2. A polyurethane (A) comprising
a) at least one organic diisocyanate or polyisocyanate,
b) at least one compound comprising at least one isocyanate-reactive group and at least one free-radically polymerizable unsaturated group and/or cationically polymerizable group,
c) at least one compound comprising at least one isocyanate-reactive group and at least one capped amino group and having a molecular weight below 1000 g/mol,
d) 1-30 mol % of at least one compound comprising at least one isocyanate-reactive group and at least one actively dispersing group,
e) if desired, at least one compound comprising at least two isocyanate-reactive groups, and
f) if desired, compounds other than a) to d) comprising at least one isocyanate-reactive group.

3. A polyurethane (A) comprising
a) at least one (cyclo) aliphatic organic diisocyanate or polyisocyanate,
b) at least one compound comprising at least one isocyanate-reactive group and at least one free-radically polymerizable unsaturated group and/or cationically polymerizable group,
c) at least one compound comprising at least one isocyanate-reactive group and at least one capped amino group and having a molecular weight below 1000 g/mol,
d) if desired, at least one compound comprising at least one isocyanate-reactive group and at least one actively dispersing group,
e) no compound comprising at least two isocyanate-reactive groups, and
f) if desired, compounds other than a) to d) comprising at least one isocyanate-reactive group.

4. The polyurethane (A) according to claim 1, wherein synthesis component c) has a molecular weight below 750 g/mol.

5. The polyurethane according to claim 1, comprising per 100 g of compound at least 0.01 mol of unsaturated free-radically or cationically polymerizable groups and/or at least 0.01 mol of capped amino groups.

6. The polyurethane according to claim 1, wherein said at least one capped amino group is selected from the group consisting of open-chain aminals, cyclic aminals, ketimines, aldimines, N,O-acetals, N,O-ketals, carboxamides, sulfonamides, and amidines.

7. The polyurethane according to claim 1, wherein component c) has the formula (I) 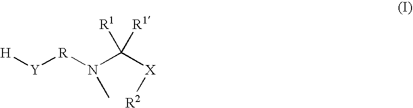
where
R and R² independently are each a divalent organic aliphatic, cycloaliphatic or aromatic radical comprising 2 to 20 carbon atoms which is unsubstituted or substituted by functional groups, aryl, alkyl, aryloxy, alkyloxy, halogen, heteroatoms and/or heterocycles,
R¹ and R^{1′} independently are each hydrogen, C₁-C₁₈ alkyl, C₂-C₁₈ alkyl which is uninterrupted or interrupted by one or more oxygen and/or sulfur atoms and/or by one or more substituted or unsubstituted imino groups, or are each C₆-C₁₂ aryl, C₅-C₁₂ cycloalkyl or a five- or six-membered heterocycle containing oxygen, nitrogen and/or sulfur atoms, it being possible for each of said radicals to be substituted by functional groups, aryl, alkyl, aryloxy, alkyloxy, halogen, heteroatoms and/or heterocycles,
X is oxygen (—O—), unsubstituted or monosubstituted nitrogen (—N(R⁴)—) or >N—NR⁴R⁵,
Y is oxygen (—O—), unsubstituted nitrogen (—N(H)—) or sulfur (—S—), and
R⁴ and R⁵ independently are each hydrogen or C₁-C₄ alkyl.

8. The polyurethane according to claim 1, comprising at least one of the following compounds of the formula (II) 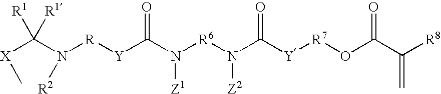
or higher homologs thereof,
where
R and R² independently are each a divalent organic aliphatic, cycloaliphatic or aromatic radical comprising 2 to 20 carbon atoms which is unsubstituted or substituted by functional groups, aryl, alkyl, aryloxy, alkyloxy, halogen, heteroatoms and/or heterocycles,
R¹ and R^{1′} independently are each hydrogen, C₁-C₁₈ alkyl, C₂-C₁₈ alkyl which is uninterrupted or interrupted by one or more oxygen and/or sulfur atoms and/or by one or more substituted or unsubstituted imino groups, or are each C₆-C₁₂ aryl, C₅-C₁₂ cycloalkyl or a five- or six-membered heterocycle containing oxygen, nitrogen and/or sulfur atoms, it being possible for each of said radicals to be substituted by functional groups, aryl, alkyl, aryloxy alkyloxy, halogen, heteroatoms and/or heterocycles,
X is oxygen (—O—), unsubstituted or monosubstituted nitrogen (—N(R⁴)—) or >N—NR⁴R⁵,
Y is oxygen (—O—), unsubstituted nitrogen (—N(H)—) or sulfur (—S—),
Y′ can be as defined for Y but can also be different,
R⁶ and R⁷ each independently are a divalent organic aliphatic, cycloaliphatic or aromatic radical comprising 2 to 20 carbon atoms and unsubstituted or substituted by functional groups, aryl, alkyl, aryloxy, alkyloxy, halogen, heteroatoms and/or heterocycles,
R⁸ is hydrogen, methyl, ethyl or hydroxymethyl, and
Z¹ and Z² can be identical or different and independently of one another are hydrogen or —(CO)—NH—R⁶—NCO.

9. A polyurethane dispersion comprising
(A) a polyurethane according to claim 1 and comprising component d) and
(C) if desired, one or more photochemically and/or thermally activable initiators, and
(D) if desired, further, typical coatings additives.

10. A coating composition comprising
said polyurethane dispersion according to claim 9 and
(C) if desired, one or more photochemically and/or thermally activable initiators, and
(D) if desired, further, typical coatings additives.

11. A method of coating a substrate, which comprises radiation curing a substrate coated with said polyurethane as claimed in claim 1, and thermally treating said polyurethane at temperatures up to 160° C.

12. The method according to claim 11, wherein said thermally treating takes place between 60 and 160° C.

13. The method according to claim 11, wherein the radiation curing is conducted under inert gas.

14. A radiation-curable coating composition comprising said polyurethane according to claim 1.

15. A method for coating wood, metal or plastic, said method comprising coating said wood, metal, or plastic with said polyurethane according to claim 1.

16. an automotive paint or automotive topcoat material comprising said polyurethane as claimed in claim 1.

17. A coating composition comprising
said polyurethane (A) according to claim 1 and
(C) if desired, one or more photochemically and/or thermally activable initiators, and
(D) if desired, further, typical coatings additives.

18. A method for coating wood, metal or plastic, said method comprising coating said wood, metal, or plastic with said polyurethane dispersion according to claim 9.
